(19) United States
(12) Patent Application Publication
(10) Pub. No.: US 2016/0336784 A1
(43) Pub. Date: Nov. 17, 2016

(54) RECONFIGRABLE CHARGING STATION FOR EXTENDED POWER CAPABILITY AND ACTIVE AREA

(71) Applicant: INTEL CORPORATION, Santa Clara, CA (US)

(72) Inventors: Songnan Yang, San Jose, CA (US); Essam Elkhouly, Santa Clara, CA (US); Bin Xiao, San Ramon, CA (US); Janardhan Koratikere Narayan, Fremont, CA (US)

(73) Assignee: INTEL CORPORATION, Santa Clara, CA (US)

(21) Appl. No.: 14/864,581

(22) Filed: Sep. 24, 2015

Related U.S. Application Data
(60) Provisional application No. 62/162,148, filed on May 15, 2015.

(51) Int. Cl. H02J 7/02; H02J 7/04

(52) U.S. Cl. CPC H02J 7/025; H02J 7/04

(57) ABSTRACT

The disclosure relates to a method, apparatus and system for reconfigurable wirelessly charging architecture for extended power capability and charging area. In certain embodiments, the disclosed embodiments relate provide a scalable wireless charging architecture which may include a constant voltage operating point between power amplifier (PA) and resonator modules to thereby support dynamic expansion of service area for larger infrastructure deployment.

The disclosure claims priority to the filing date of Provisional Application No. 62/162,148, filed May 15, 2015, the specification of which is incorporated herein in its entirety.

### BACKGROUND

1. Field

The disclosure relates to improved wireless charging stations. Specifically, the disclosed embodiments provide scalable wireless charging architecture which may include a constant voltage operating point between power amplifier (PA) and resonator modules to support dynamic expansion of service area. The disclosed embodiments enable large infrastructure deployment and dynamic scalability.

2. Description of Related Art

Wireless charging or inductive charging uses a magnetic field to transfer energy between two devices. Wireless charging can be implemented at a charging station. Energy is sent from one device to another device through an inductive coupling. The inductive coupling is used to charge batteries or run the receiving device. The Alliance for Wireless Power (A4WP) was formed to create industry standard to deliver power through non-radiative, near field, magnetic resonance from the Power Transmitting Unit (PTU) to a Power Receiving Unit (PRU).

The A4WP defines five categories of PRU parameterized by the maximum power delivered out of the PRU resonator. Category 1 is directed to lower power applications (e.g., Bluetooth headsets). Category 2 is directed to devices with power output of about 3.5 W and Category 3 devices have an output of about 6.5 W. Categories 4 and 5 are directed to higher-power applications (e.g., tablets, netbooks and laptops).

PTUs of A4WP use an induction coil to generate a magnetic field from within a charging base station, and a second induction coil in the PRU (i.e., portable device) takes power from the magnetic field and converts the power back into electrical current to charge the battery. In this manner, the two proximal induction coils form an electrical transformer. Greater distances between sender and receiver coils can be achieved when the inductive charging system uses magnetic resonance coupling. Magnetic resonance coupling is the near field wireless transmission of electrical energy between two coils that are tuned to resonate at the same frequency.

Wireless charging is particularly important for mobile devices including smartphones, tablets and laptops. There is a need for scalable wireless charging systems to provide a large charging area capable of simultaneously charging of multiple devices.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic overview of wireless charging infrastructure according to one embodiment of the disclosure;

FIG. 2 shows a conventional wireless charging architecture for an A4WP charging station;

FIG. 3A shows an exemplary scalable wireless charging architecture according to one embodiment of the disclosure;

FIG. 3B shows an exemplary impedance inversion circuit build from a Pi-Network;

FIG. 3C shows an exemplary impedance inversion circuit build from a T-Network;

FIG. 4 shows an exemplary embodiment of the disclosure with multiple resonator modules;

FIG. 5 shows an exemplary embodiment of the disclosure having multiple power amplifier modules and scalable resonator modules;

FIG. 6A shows a scalable wireless charging station according to one embodiment of the disclosure;

FIG. 6B is an exploded view of a reactance shift detection and adaptive tuning system according to one embodiment of the disclosure;

FIG. 7 shows an exemplary embodiment according to one embodiment of the disclosure to support dynamic configuration of PA modules;

FIG. 8 shows an exemplary diagram for maintaining a constant Vtx according to one embodiment of the disclosure;

FIG. 9A shows a wireless charging prototype with four active areas according to one embodiment of the disclosure;

FIG. 9B shows a resonator module having a tuned resonator and impedance inversion circuitries;

FIG. 10 shows an exemplary wireless charging prototype with scalable architecture; and

FIG. 11 shows an exemplary configurations of partially overlapped small coil arrays according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 December, 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HD™ specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

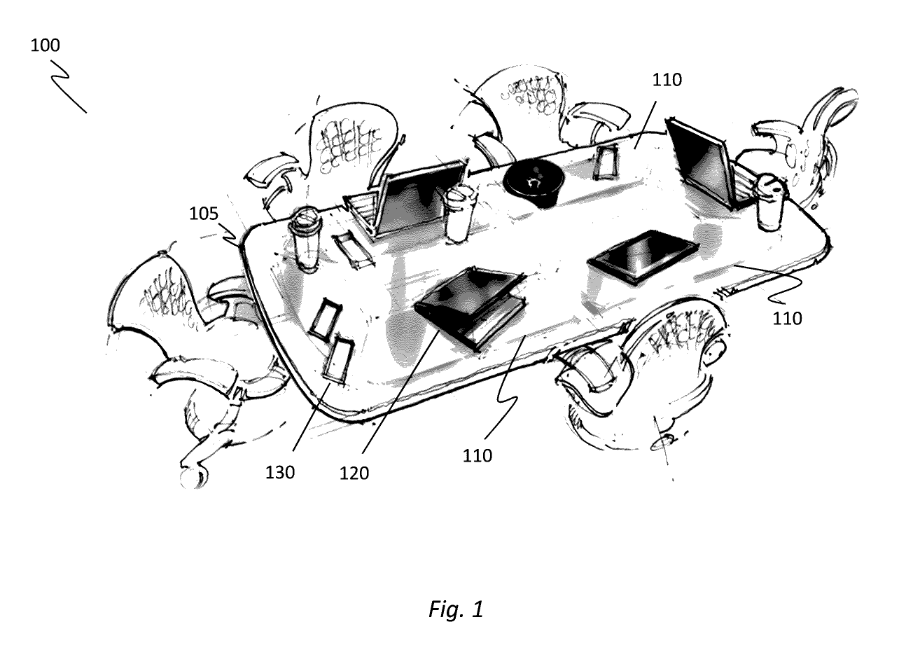

Ubiquitous availability of wireless chargers in places such as offices, conference rooms, coffee shops, airports, hotels and the like is highly desirable. Conventional A4WP specification, however, does not adequately support scalability for infrastructure deployment. For example, the current A4WP specification describes a single PTU of a given power class driving a single coil with a specific current (Itx), which charges multiple PRUs. However, for infrastructure deployment, such as in the case of a conference room shown in FIG. 1, multiple charging active areas are required with each supporting multiple devices. This is due to the fact that it is impractical to have one large coil covering the entire table. A large coil causes poor coupling between the coil and small devices. It is also not practical nor economical to deploy one dedicate PTU per active area as the PTU circuitry is costly. Lastly, having multiple PTU coils in close proximity to each other and powered by several uncoordinated PTUs is challenging from both coupling and cross talk perspectives.

An embodiment of the disclosure relates to a scalable wireless charging PTU architecture compliant with the current A4WP standard. In certain embodiments, the disclosure provides an extended, modular, PTU. The modular PTU may include coils/resonators and power amplifiers. The exemplary modular PTU enables dynamic expansion of active charging area and wireless power supply capabilities. The disclosed architecture eases implementation and accelerates infrastructure adoption of wireless charging.

FIG. 1 illustrates an exemplary wireless charging infrastructure. In FIG. 1, conference room 100 is shown with wireless charging pads (i.e., PTUs) 110 positioned on desk 105. Each PTU 110 is designated to support one or more PRUs. While FIG. 1 shows PRUs including laptop 120 and smart devices 130, the disclosed principles are not limited thereto and may include any device capable of wireless charging.

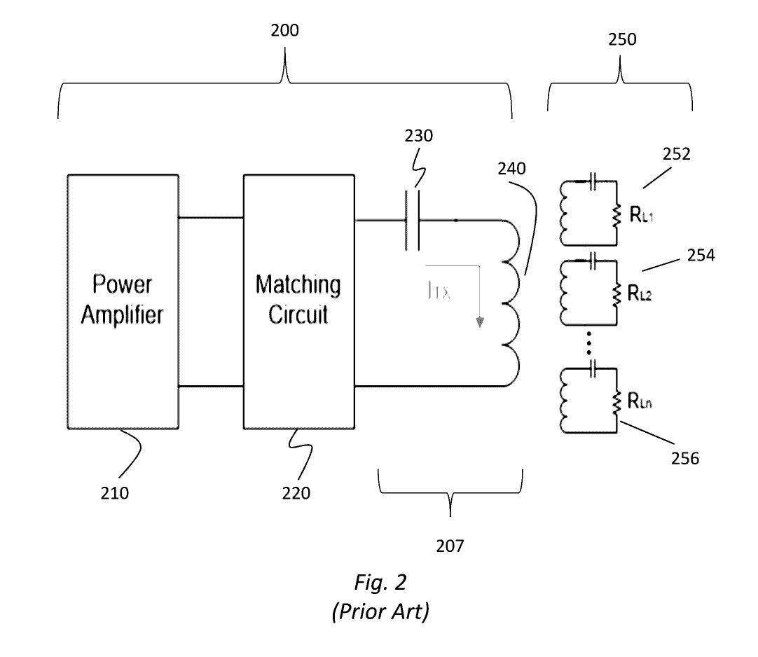

FIG. 2 shows a conventional wireless charging architecture compliant with the A4WP standard. In FIG. 2, section 200 defines the PTU circuits and includes power amplifier (PA) 210 and matching circuit 220 connected in series to tuning capacitor 230 and coil 240. Section 250 is the PRU circuitry and includes resonator coils 252, 254 and 256. The architecture of FIG. 2 defines a current source driving a series tuned coil 240. This architecture supports resonator coils 252, 254 and 256 to be charged by PTU 200. The function of matching circuit 220 between PA 210 and resonator 207 is to convert the PA's output to a constant current (Itx).

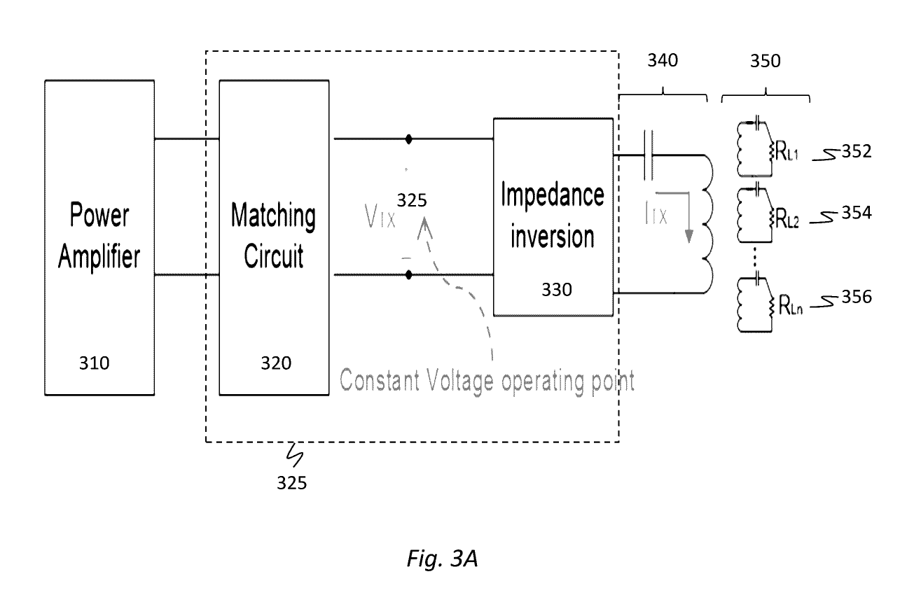

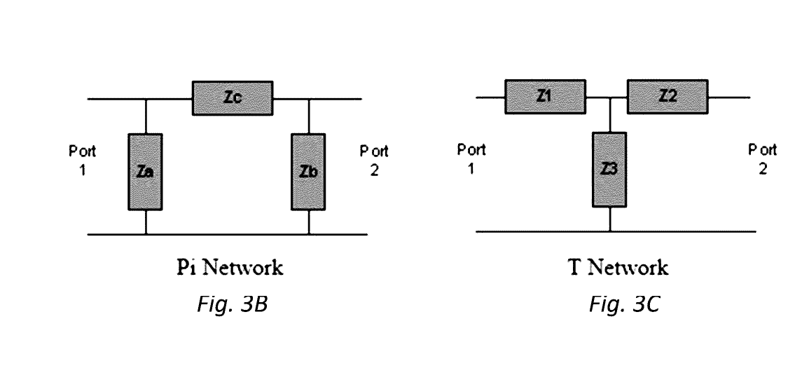

FIG. 3A shows an exemplary scalable wireless charging architecture according to one embodiment of the disclosure. FIG. 3A includes PA 310, matching circuit 320, impedance inversion circuitry 330, resonator 340 and PRUs 350 which include coils 352, 354 and 356. In FIG. 3A, circuit 325 provides a substantially constant voltage in two parts. The first part, identified as sections 320 and 325, converts the PA's output to a substantially constant voltage source with AC voltage of Vtx (an AC current with predefined frequency). The second part of the matching network serves as an impedance inversion circuit 330, which offers about 90 degree phase shift and impedance transformation that converts the constant AC voltage (Vtx) to substantially constant current output for the tuned resonator 340. The impedance transformation ensures proper current Itx is supplied to PTU resonator 340. In certain embodiments, the phase shift may be 90 degrees or 270 degrees or any odd multiple of 90 degrees.

Conventional impedance inversion circuits may be used for the circuit of FIG. 3A. For example, FIG. 3B shows an exemplary impedance inversion circuit build from a Pi-Network and FIG. 3C shows an exemplary impedance inversion circuit build from a T-Network. In the impedance inversion circuits of FIGS. 3B and 3C when the Port 1 and Port 2 has characteristic impedance R1 and R2 respectively, and the impedances of the Pi- and T-network components that offers 90 degree phase shift can be calculated as shown in Equations (1) and (2):

Za=Zb=Z3=−j*sqrt(R1*R2) Eq. (1)

Zc=Z1=Z2=j*sqrt(R1*R2) Eq. (2)

The exemplary embodiment of FIG. 3A, which incorporates a system with substantially constant voltage, complies with the A4WP standard by providing constant current at resonator 340. The disclosed embodiment also allows the wireless charging system to be scalable from resonator side 350 to support a larger active area. In one embodiment, the number of resonators 340 may be increased to cover a larger surface area. On the PTU PA circuit side, the disclosed embodiment provides scalable power.

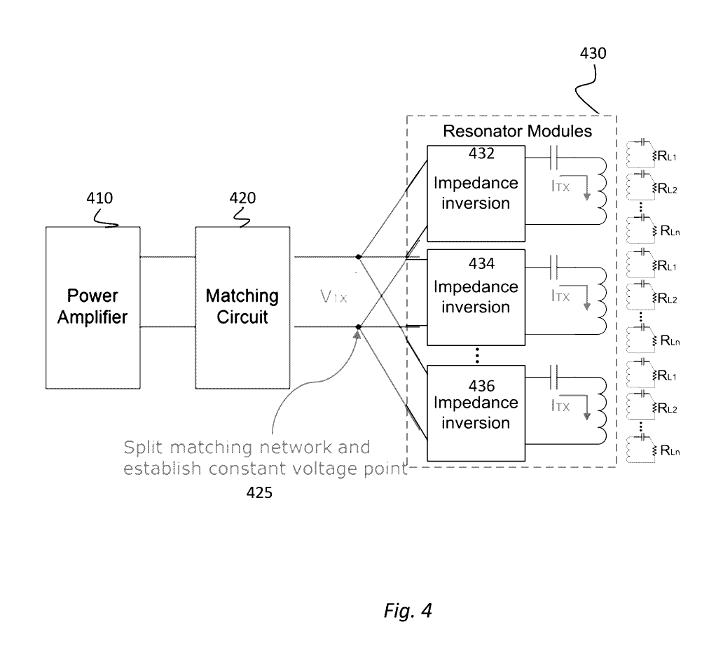

FIG. 4 shows an exemplary embodiment of the disclosure with multiple PTU resonator modules. Specifically, FIG. 4 shows PA 410, matching circuit 420, resonator modules 430 which include impedance inversion circuits 432, 434 and 436 which correspond to tuned PTU resonators 442, 444 and 446. Each tuned coil module 442, 444 . . . 446 may engage multiple PRU devices for wireless charging.

In the topology of FIG. 4, when more active areas are needed, more resonator modules may be added in parallel to the existing resonator circuit at the newly established constant voltage point 425. Similar impedance inversion circuits may be used to convert the constant voltage provided by PA 410 to constant current on the newly added resonator(s) of resonator modules 430. Each of the newly added resonators (not shown) may establish a new active charging area that can support multiple devices with different power profiles consistent with the current A4WP standard.

When a new PRU device is placed within the active area of the added resonator(s), the load is converted by the resonator and impedance inversion circuit to be added across the constant voltage point, and power pulled from the PA circuit will naturally increase to charge the introduced PRU device.

In an exemplary embodiment, a controller and related circuitry (not shown) may be used to engage additional resonator modules as needed. The controller may be prompted to engage additional resonator modules manually (i.e., by operator action) or upon detecting presence of additional PRUs. When engaging additional resonator modules, the controller and circuitry (not shown) may also communicate with power amplifier 410 and matching circuit 420 to enable powering the additional resonator modules 430.

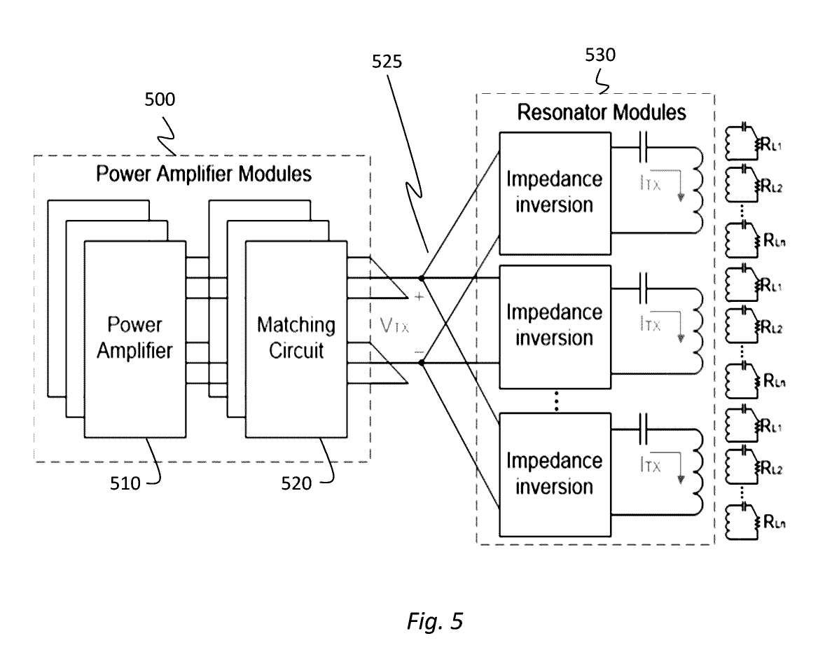

FIG. 5 shows an exemplary embodiment of the disclosure having multiple power amplifier modules and scalable resonator modules. Specifically, FIG. 5 shows power amplifier modules 500 including multiple power amplifiers 510 with respective multiple matching circuits 520. In one embodiment, each power amplifier communicates with a respective matching circuit.

When multiple resonator modules are added and more devices are being charged, the combination of one power amplifier and one matching circuit may not be able to sustain a constant voltage (Vtx). Similar to the expansion of resonator modules of FIG. 4, in FIG. 5, power amplifiers 510 and matching circuits 520 are added in parallel to the constant voltage point 525 to help provide more power to the resonator modules 530 which in turn help maintain the voltage (Vtx) constant.

In one embodiment of the disclosure power amplifier module 500 may include one, two or more power amplifiers 510 and matching circuits 520. Each power amplifier 510 may be connected in series to one matching circuit 520. A combination one power amplifier and one matching circuit may be repeated to form two or more power amplifier modules 500. The number of power amplifier modules may be configured to correlate to number of resonator modules. That is, for each resonator module (e.g., impedance inversion circuit connected to a coil) there may be a dedicated power amplifier module. In certain embodiments, there may be two or more resonator modules 530 for each power amplifier modules 500. The relationship between the number of resonator modules and power amplifier modules may be configured to provide a substantially constant voltage (Vtx) at interface 525.

In an exemplary embodiment, a control circuitry (not shown) may be added to increase the number of active power amplifier modules 500 as the load demand increases (i.e., as the number of active resonator modules 530 increase in response to devices under charge). The control circuitry may be autonomously activated when additional chargeable devices are detected proximal to the charging station, may be manually activated by an operator or a combination of the two.

The disclosed embodiments are advantageous for several reasons. For infrastructure deployment, if multiple PTU resonators are to be supported, a current source is needed to drive the multitude of PTU coil in series. This may not be practical for dynamic reconfiguration or selective expansion of active area. Similarly, maintaining a constant current while load devices' power demand increases is difficult to achieve with the conventional A4WP architecture. The disclosed expansion of A4WP architecture addresses this shortcoming by establishing a common interface of constant voltage (Vtx) between PA and the resonators. The common interface (i.e., 525 at FIG. 5) allows expansion of both active area and power capabilities through adding PA and resonator modules in parallel while maintaining A4WP compliance. The following exemplary embodiments and implementations of the disclosed principles illustrate additional solutions for specific problems associated with the conventional A4WP wireless charging systems.

Reactance Shift Compensation—

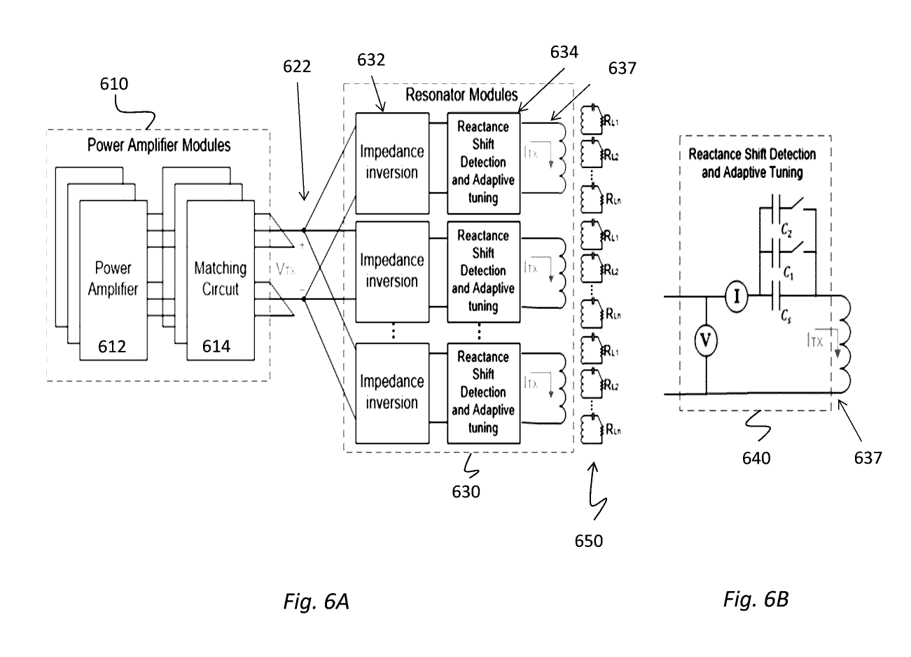

FIG. 6 shows an exemplary reactance shift compensation circuit according to one embodiment of the disclosure. Specifically, FIG. 6A shows an exemplary embodiment of a reactance shift detection and adaptive tuning circuitry 634. The embodiment of FIG. 6A includes PA multiple PAs 612 and multiple matching circuits 614. Each PA may communicate with a respective matching circuit. Constant voltage point 622 is interposed between PA modules 610 and Resonator Modules 630. The Resonator Modules 630 may include multiple impedance inversion circuitry 632 communicating with a respective reactance shift detection and adaptive tuning circuit 634.

FIG. 6B shows an exemplary circuitry for the reactance shift detection and adaptive tuning system according to one embodiment of the disclosure. The exemplary embodiment may include several capacitors connected in parallel (C₁, C₂ . . . Cₛ). The capacitors may be connected in series with an inductor to form a resonating circuit. FIG. 6B shows an exemplary implementation of reactance shift detection and adaptive tuning circuit where the current (I) and voltage (V) at input of the resonator (e.g., 637) is measured to determine the reactance shift, while multitude of tuning components and switches are added to the main tuning capacitor to realize the adaptive tuning functions. In the scalable architecture of FIG. 6A, the reactance shift detection and adaptive tuning circuit may to be implemented on each resonator module such that proper power/current distribution among resonator modules can be maintained at the constant voltage (Vtx) point. In certain embodiments, the switchable tuning capacitors (C1, C₂ . . . ) may be connected in parallel to the switching device and connected in series to the series tuning capacitor (Cs).

When the PRU devices 650 are presented to the PTU resonators, the metallic chassis/component inside the PRU devices causes the PTU resonator to detune and present a load with large reactive part to the PTU circuit. In A4WP designs, a reactance shift detection circuit along with adaptive tuning circuit may be used to dynamically compensate for reactance shift caused on the PTU resonator such that it always present a mostly real load to the PA circuitry.

Sustaining Constant Voltage (Vtx)—

In order to adequately sustain Vtx at a constant level during charging operation while conserving energy when the load is light, a procedure of dynamic control of multiple PA modules can be implemented according to one embodiment of the disclosure.

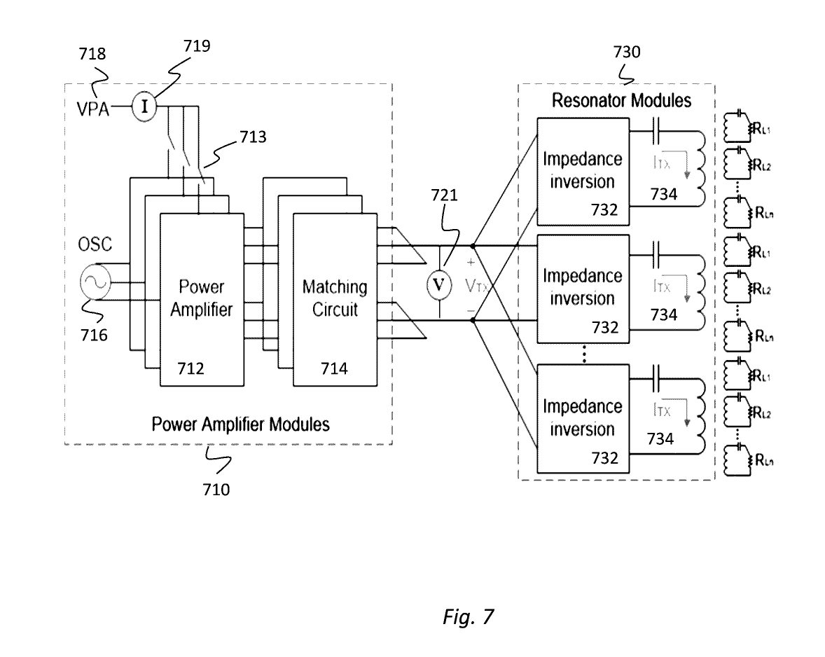

FIG. 7 shows an exemplary embodiment to support dynamic configuration of power amplifier modules. FIG. 7 shows oscillator 716 coupled to a plurality of power amplifier modules 710. Each power amplifier module 710 includes a power amplifier 712 connected in series to matching circuit 714. In addition, a voltage source 716 is connected to each power amplifier 712 through an optional switch 713. Resonator modules 730 are also shown to include a plurality of impedance inversion circuitry 732 and tuned coil modules 734.

As shown in FIG. 7, all power amplifier modules 712 are synchronized with the same oscillator/frequency synthesizer 716 to ensure in-phase combination of output AC power. A current detection mechanism 719 is added to the DC power supply 718 of the PA modules and a voltage sampling circuit 721 is added at output of PA modules to monitor change in Vtx.

The system of FIG. 7 periodically monitors the Ipa and Vtx values and compares them to set threshold values (not shown). In FIG. 7 Ipa denotes current supplied to each power amplifier and Vpa denotes supply voltage of each power amplifier. The threshold voltage (Vpa_th) and threshold current (Ipa_th) values may be stored at a local memory (not shown). A controller (not shown) may compare Vpa and/or Ipa to its respective threshold values (Vpa_th and Ipa_th) to determine whether adjustment must be made. Finally, a decision can be then made as to whether switch in/out power amplifier modules.

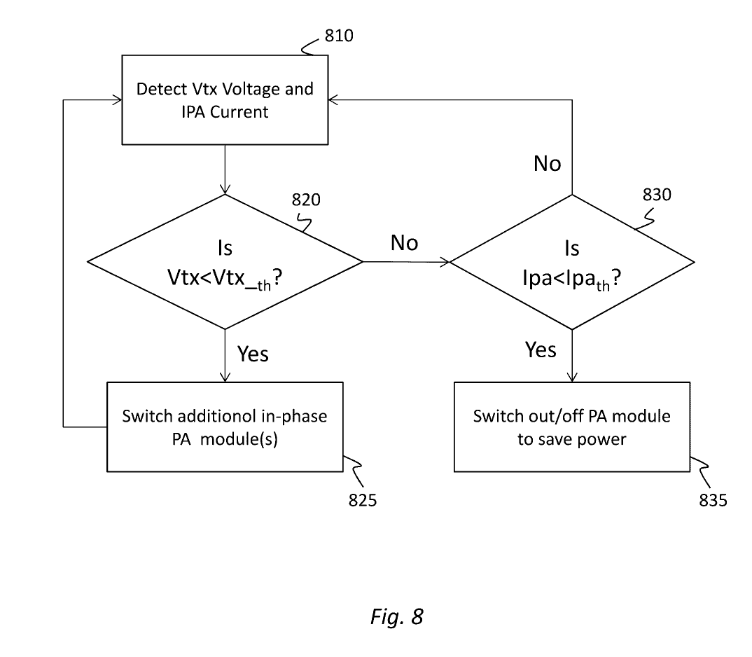

FIG. 8 shows an exemplary process diagram for maintaining a constant Vtx according to one embodiment of the disclosure. The steps of the process diagram of FIG. 8 may be made in relation to any of the disclosed embodiments, for example, in relation to the embodiment of FIG. 7. The process of FIG. 8 may start at step 810 upon detection of an external event such as change in current draw and/or voltage change on Vtx.

At step 820, as a heavy load is pulling the Vtx value lower than its threshold set (Vtx_th), more in-phase PA modules may be switched in to the system to help sustain a constant Vtx. At step 830, when lighter load is presented to the power amplifiers (e.g., PA 730, FIG. 7) and if the current pulled from all PA modules combined is less than a predefined Ipa threshold value (Ipa_th), then one or more PA modules may be switched out of the system to conserver power as shown in step 835.

The process diagram of FIG. 8 may be implemented at a processor circuitry (not shown) in communication with a memory circuitry (not shown). The memory circuitry may store threshold values and instructions for the controller to implement steps comprising those shown and discussed in relation to FIG. 8. The processor and memory circuitries may be implemented in hardware, software or a combination of hardware and software. In an exemplary embodiment, these steps may be stored at a machine readable medium such as hard-drive, optical drive, Random Access Memory (RAM) or any conventional machine (interchangeably, computer) readable storage device. The machine readable storage medium may define a non-transitory storage medium.

Coil Configurations—

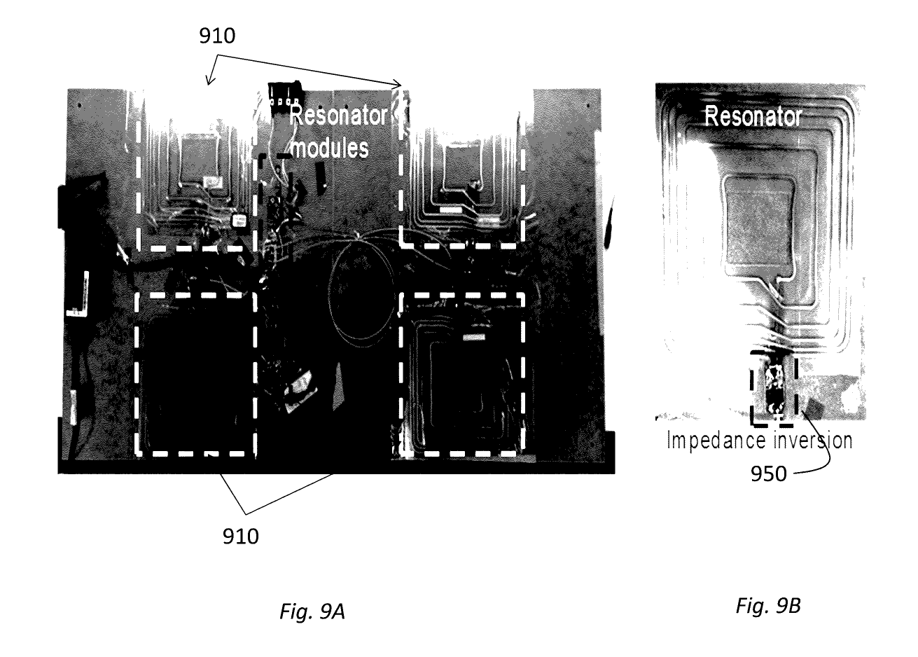

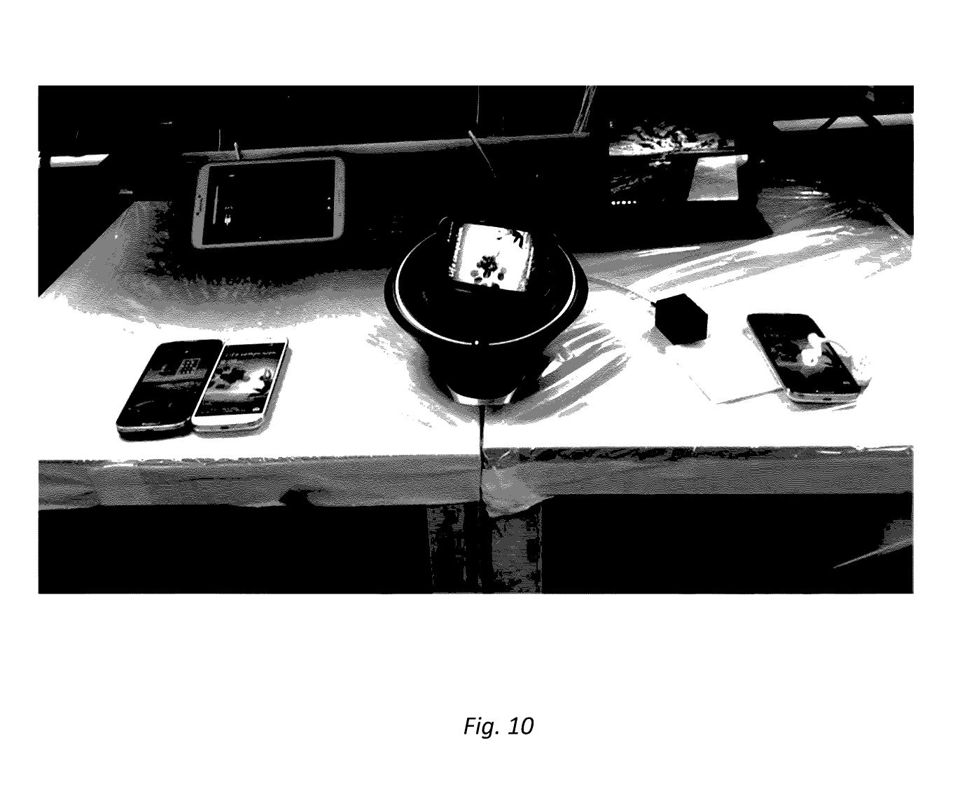

Multiple coil configuration may be supported by the disclosed principles and illustrated architectures. For example, multiple large coils 910 may be powered by the same power amplifier circuitry to support multiple active areas. FIG. 9A shows a prototype system that uses the same power amplifier module 920 to power four (4) resonator modules 910. More specifically, FIG. 9A is a photograph reproduction of a wireless charging table prototype in which four (4) active areas (identified as resonator modules 910) are created based on the disclosed architecture. Resonator modules 910 are shown with yellow dashed lines. As seen in FIG. 9B, each tuned resonator may be followed by impedance inversion circuit 950 to form a resonator modules according to certain disclosed embodiments. In one embodiment, all of the resonator modules may be connected in parallel to the constant voltage output of the PA with matching network. The coils may be formed according to the embodiment of FIG. 9A or in any other manner without departing from the disclosed principles.

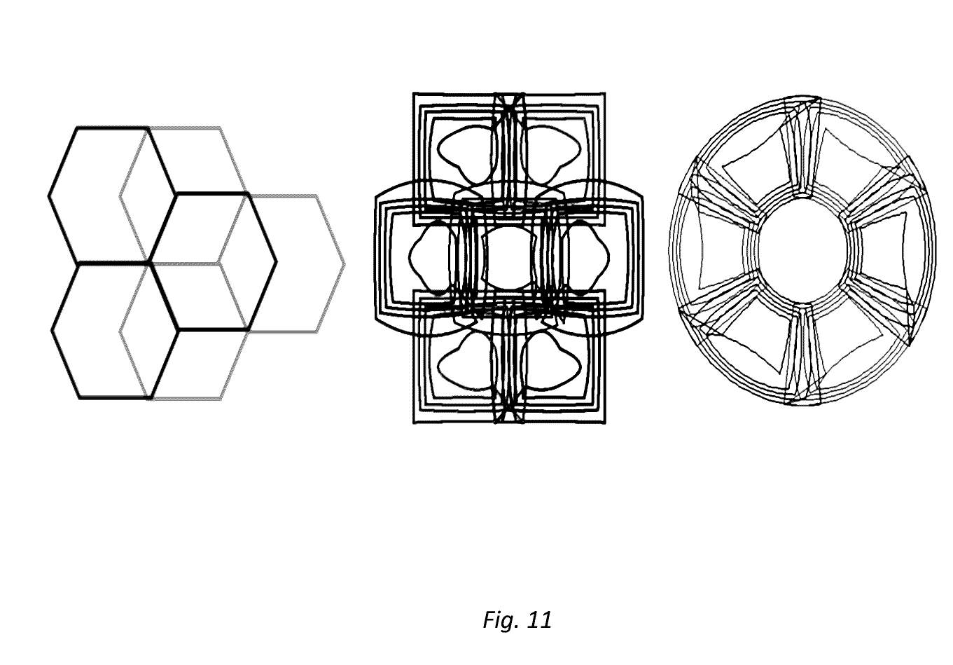

FIG. 10 shows another exemplary implementation of a scalable wireless charging device with scalable architecture. The prototype shown in FIG. 10 can simultaneously support 4 active areas and more than ten devices to be simultaneously charged by one power amplifier module. The prototype of FIG. 10 may also allow dynamic enabling/disabling of individual active areas as discussed above.

In another embodiment, the disclosure provides a tiling and/or partial overlap of resonators to form a larger combined active area. The overlapping of the resonator coils may extend the available charging area to thereby support multiple devices simultaneously. The embodiments disclosed above may be incorporated with a tiled or partially overlapping resonator coils.

FIG. 11 shows exemplary configurations of partially overlapped small coil arrays according to one embodiment of the disclosure. As shown in FIG. 11, the disclosed embodiments support smaller resonators to be arranged close to each other even partially overlap to form a combined large active area. Here, one or more selected resonator modules may be required to be enabled to perform the power transfer while the resonators not aligned with a PRU devices can remain disconnected to conserve power, reduce interference and avoid coexistence problems.

The following non-liming examples are provided to illustrate different embodiments of the disclosure. Example 1 relates to a power transmission unit (PTU), comprising: a power amplifier configured to provide an output current; a matching circuit coupled to the power amplifier to convert the output current of the power amplifier to a substantially constant voltage (Vtx); an impedance inversion circuitry coupled to the matching circuitry, the impedance inversion circuitry to receive the substantially constant voltage output (Vtx) from the matching circuit and provide a substantially constant current (Itx); and a resonator to receive the substantially constant current from the impedance inversion circuitry.

Example 2 relates to the PTU of example 1, wherein the impedance inversion circuitry phase shifts the substantially constant voltage output (Vtx) of the matching circuit by about 90 degrees.

Example 3 relates to the PTU of example 1, wherein the resonator is a tunable resonator.

Example 4 relates to the PTU of example 3, wherein the resonator further comprises of a plurality of resonator modules connected in parallel.

Example 5 relates to the PTU of example 4, wherein at least one resonator module further comprises a reactance shift detection and compensation circuitry to detect reactance of the resonator coil and to tune the output of the impedance inversion circuitry to about resonance with the resonator coil.

Example 6 relates to a power transmission unit (PTU), comprising: a first circuitry to provide a substantially constant output voltage (Vtx), the first circuitry having a plurality of power amplifiers coupled to a plurality of matching circuits, respectively; a second circuitry to receive and convert the substantially constant output voltage (Vtx) to a substantially constant current (Itx), the second circuitry having a plurality of resonator modules corresponding to each of the plurality of power amplifiers; a controller to detect external load and engage one or more of the plurality of power amplifiers in response to the detected external load.

Example 7 relates to the PTU of example 6, wherein the controller engages a corresponding number of power amplifiers, matching circuits and resonator modules in response to the detected external load.

Example 8 relates to the scalable PTU of example 7, wherein the controller determines how many of the plurality of power amplifiers, matching circuits and resonator modules to engage.

Example 9 relates to the PTU of example 6, wherein at least one resonator module further comprises an impedance inversion circuitry connected to tuning circuitry and wherein the at least one resonator module phase shifts the substantially constant voltage output (Vtx) to provide a substantially constant current output (Itx).

Example 10 relates to the scalable PTU of example 9, wherein the impedance inversion circuitry is configured to phase shift the substantially constant voltage output (Vtx) by 90 degrees.

Example 11 relates to the scalable PTU of example 9, wherein at least one resonator module further comprises a reactance shift detection and compensation circuitry to detect reactance of the resonator coil and to tune the output of the impedance inversion circuitry to about resonance with the resonator coil.

Example 12 relates to the scalable PTU of example 6, wherein the resonator module further comprises a plurality of resonator coils.

Example 13 relates to a method for wirelessly charging a mobile device, the method comprising: amplifying an alternating current (AC) input voltage to provide an first voltage; conditioning the first voltage to provide a substantially constant output voltage (Vtx); converting the substantially constant voltage (Vtx) to a substantially constant current (Itx) output; tuning the substantially constant current (Itx) output to electromagnetically engaging and wirelessly charging one or more resonator coils.

Example 14 relates to the method of example 13, further comprising phase-shifting shifts the substantially constant voltage output (Vtx) to provide a phase-shifted substantially constant current output (Itx).

Example 15 relates to the method of example 14, further comprising phase-shifting the substantially constant voltage (Vtx) by about 90°.

Example 16 relates to the method of example 14, further comprising detecting a number of electromagnetically engaged resonator coils.

Example 17 relates to the method of example 16, further comprising selectively engaging a number of parallel circuits to condition the first voltage to provide an amplified substantially constant output voltage (Vtx) and to convert the substantially constant voltage (Vtx) to the substantially constant current (Itx) output in response to the detected number of engaged resonator coils.

Example 18 relates to the method of example 17, further comprising synchronizing the plurality of parallel circuits to an oscillator to provide in-phase combination of AC input voltage.

Example 19 relates to the method of example 18, further comprising sampling the AC input and the substantially constant voltage (Vtx) and comparing the samplings to one or more threshold values.

Example 20 relates to the method of example 14, further comprising measuring reactance shift as a function of at least one of substantially constant current, the resonator input voltage and the phase between the current and voltage.

Example 21 relates to a non-transitory machine-readable storage medium storing instructions which, when executed, causes wireless charging of an external device by performing a method comprising: amplifying an alternating current (AC) input voltage to provide an first voltage; conditioning the first voltage to provide a substantially constant output voltage (Vtx); converting the substantially constant voltage (Vtx) to a substantially constant current (Itx) output; tuning the substantially constant current (Itx) output to electromagnetically engaging and wirelessly charging one or more resonator coils.

Example 22 relates to the non-transitory machine-readable storage medium of example 21, further comprising phase-shifting shifts the substantially constant voltage output (Vtx) to provide a phase-shifted substantially constant current output (Itx).

Example 23 relates to the non-transitory machine-readable storage medium of example 22, further comprising phase-shifting the substantially constant voltage (Vtx) by about 90°.

Example 24 relates to the non-transitory machine-readable storage medium of example 21, further comprising detecting a number of electromagnetically engaged resonator coils and selectively engaging a number of parallel circuits to condition the first voltage to provide an amplified substantially constant output voltage (Vtx) and to convert the substantially constant voltage (Vtx) to the substantially constant current (Itx) output in response to the detected number of engaged resonator coils.

Example 25 relates to the non-transitory machine-readable storage medium of example 24, further comprising synchronizing the plurality of parallel circuits to an oscillator to provide in-phase combination of AC input voltage.

While the principles of the disclosure have been illustrated in relation to the exemplary embodiments shown herein, the principles of the disclosure are not limited thereto and include any modification, variation or permutation thereof.

What is claimed is:

1. A power transmission unit (PTU), comprising:
a power amplifier configured to provide an output current;
a matching circuit coupled to the power amplifier to convert the output current of the power amplifier to a substantially constant voltage (Vtx);
an impedance inversion circuitry coupled to the matching circuitry, the impedance inversion circuitry to receive the substantially constant voltage output (Vtx) from the matching circuit and provide a substantially constant current (Itx); and
a resonator to receive the substantially constant current from the impedance inversion circuitry.

2. The PTU of claim 1, wherein the impedance inversion circuitry phase shifts the substantially constant voltage output (Vtx) of the matching circuit by about 90 degrees.

3. The PTU of claim 1, wherein the resonator is a tunable resonator.

4. The PTU of claim 3, wherein the resonator further comprises of a plurality of resonator modules connected in parallel.

5. The PTU of claim 4, wherein at least one resonator module further comprises a reactance shift detection and compensation circuitry to detect reactance of the resonator coil and to tune the output of the impedance inversion circuitry to about resonance with the resonator coil.

6. A power transmission unit (PTU), comprising:
a first circuitry to provide a substantially constant output voltage (Vtx), the first circuitry having a plurality of power amplifiers coupled to a plurality of matching circuits, respectively;
a second circuitry to receive and convert the substantially constant output voltage (Vtx) to a substantially constant current (Itx), the second circuitry having a plurality of resonator modules corresponding to each of the plurality of power amplifiers;
a controller to detect external load and engage one or more of the plurality of power amplifiers in response to the detected external load.

7. The PTU of claim 6, wherein the controller engages a corresponding number of power amplifiers, matching circuits and resonator modules in response to the detected external load.

8. The scalable PTU of claim 7, wherein the controller determines how many of the plurality of power amplifiers, matching circuits and resonator modules to engage.

9. The PTU of claim 6, wherein at least one resonator module further comprises an impedance inversion circuitry connected to tuning circuitry and wherein the at least one resonator module phase shifts the substantially constant voltage output (Vtx) to provide a substantially constant current output (Itx).

10. The scalable PTU of claim 9, wherein the impedance inversion circuitry is configured to phase shift the substantially constant voltage output (Vtx) by 90 degrees.

11. The scalable PTU of claim 9, wherein at least one resonator module further comprises a reactance shift detection and compensation circuitry to detect reactance of the resonator coil and to tune the output of the impedance inversion circuitry to about resonance with the resonator coil.

12. The scalable PTU of claim 6, wherein the resonator module further comprises a plurality of resonator coils.

13. A method for wirelessly charging a mobile device, the method comprising:
amplifying an alternating current (AC) input voltage to provide an first voltage;
conditioning the first voltage to provide a substantially constant output voltage (Vtx);
converting the substantially constant voltage (Vtx) to a substantially constant current (Itx) output;
tuning the substantially constant current (Itx) output to electromagnetically engaging and wirelessly charging one or more resonator coils.

14. The method of claim 13, further comprising phase-shifting shifts the substantially constant voltage output (Vtx) to provide a phase-shifted substantially constant current output (Itx).

15. The method of claim 14, further comprising phase-shifting the substantially constant voltage (Vtx) by about 90°.

16. The method of claim 14, further comprising detecting a number of electromagnetically engaged resonator coils.

17. The method of claim 16, further comprising selectively engaging a number of parallel circuits to condition the first voltage to provide an amplified substantially constant output voltage (Vtx) and to convert the substantially constant voltage (Vtx) to the substantially constant current (Itx) output in response to the detected number of engaged resonator coils.

18. The method of claim 17, further comprising synchronizing the plurality of parallel circuits to an oscillator to provide in-phase combination of AC input voltage.

19. The method of claim 18, further comprising sampling the AC input and the substantially constant voltage (Vtx) and comparing the samplings to one or more threshold values.

20. The method of claim 14, further comprising measuring reactance shift as a function of at least one of substantially constant current, the resonator input voltage and the phase between the current and voltage.

21. A non-transitory machine-readable storage medium storing instructions which, when executed, causes wireless charging of an external device by performing a method comprising:
amplifying an alternating current (AC) input voltage to provide an first voltage;
conditioning the first voltage to provide a substantially constant output voltage (Vtx);
converting the substantially constant voltage (Vtx) to a substantially constant current (Itx) output;
tuning the substantially constant current (Itx) output to electromagnetically engaging and wirelessly charging one or more resonator coils.

22. The non-transitory machine-readable storage medium of claim 21, further comprising phase-shifting shifts the substantially constant voltage output (Vtx) to provide a phase-shifted substantially constant current output (Itx).

23. The non-transitory machine-readable storage medium of claim 22, further comprising phase-shifting the substantially constant voltage (Vtx) by about 90°.

24. The non-transitory machine-readable storage medium of claim 21, further comprising detecting a number of electromagnetically engaged resonator coils and selectively engaging a number of parallel circuits to condition the first voltage to provide an amplified substantially constant output voltage (Vtx) and to convert the substantially constant voltage (Vtx) to the substantially constant current (Itx) output in response to the detected number of engaged resonator coils.

25. The non-transitory machine-readable storage medium of claim 24, further comprising synchronizing the plurality of parallel circuits to an oscillator to provide in-phase combination of AC input voltage.
